(19) United States
(12) Patent Application Publication
(10) Pub. No.: US 2011/0141101 A1
(43) Pub. Date: Jun. 16, 2011

(54) METHOD FOR PRODUCING A HEAD APPARATUS

(75) Inventor: Mark SCRIBNER, Windsor, ME (US)

(73) Assignee: TWO LOONS TRADING COMPANY, INC., Windsor, ME (US)

(21) Appl. No.: 12/635,749

(22) Filed: Dec. 11, 2009

(51) Int. Cl. G06T 17/00

(52) U.S. Cl. 345/419; 345/661; 345/620

(57) ABSTRACT

A method for producing a three-dimensional likeness of a real-life subject from a two-dimensional image. The method includes uploading a digital image including facial features of a real-life subject from local memory storage to storage in a remote server. A user of the method then selects a target image area from the digital image and matches peripheral features such as skin tone, hair style, and hair color to the real-life subject. The remote server processes the said target image area and the peripheral features together to produce a three-dimensional representation which may be previewed by the user. Once approved and purchased through an on-line e-commerce transaction, multiple two-dimensional sheets corresponding to the three-dimensional representation are generated and a tangible embodiment of the three-dimensional representation is formed from the two-dimensional sheets as a head apparatus for shipment to the user.

### FIELD OF THE INVENTION

The present invention relates generally to production of a real-life likeness. More particularly, the present invention relates to producing a three-dimensional head likeness of a real-life subject from a two-dimensional image.

### BACKGROUND OF THE INVENTION

Several prior art methods and apparatuses exist for creation of life-like dolls, toys, and related novelty items.

U.S. Pat. No. 6,782,128 issued to Rinehart on Aug. 24, 2004 shows a method for digitally editing an image of a real-life person for attaching the image to a soft-bodied doll having a generally planar face. The process includes electronically importing an image into a computer by use of a scanner, a digital camera, a compact disc, or an attachment to an e-mail, to produce a digital image file. The image is then digitally edited using any image editor. The face is masked while the neck of the person and background of the image are deleted. A portion of the person's cheek is then sampled and lightened slightly to form a neck color which then fills in the previously deleted portion. In a second embodiment, only the eyes, nose and mouth are masked while the rest of the image is either tinted to a chosen color corresponding to the color of fabric used in producing the doll, or partially erased to allow the chosen background color to blend through and create a color match between the facial images and the cloth body. In a third embodiment, the image is lightened in color to allow the color of the fabric used in producing the doll to bleed through the image. In this embodiment, the eyes and teeth are first whitened as much as possible. In a fourth embodiment, all areas of the photograph except the eyes, nose and mouth areas are removed and the resulting image is transferred to the face of the doll.

U.S. Pat. No. 6,549,819 issued to Danduran et al. on Apr. 15, 2003 shows a method of producing three-dimensional copies of individual human faces and heads that employs a method of production in which all of the components except for the face area are standardized. This method of construction vastly reduces the costs involved in the production of these types of models and allows for the generation of three-dimensional models of individual faces at costs that will make them available to a greater portion of the population as a whole.

U.S. Pat. No. 5,906,005 issued to Niskala et al. on May 25, 1999 shows a method of making a mask representing a photographic subject that includes the steps of: simultaneously capturing a front and two side face views of the subject using a single camera and a pair of mirrors, one mirror on each side of the subject's head; forming a digital image of the captured front and side views; digitally processing the digital image by mirroring the two side views and blending the two side views with the front view to form a blended image; and transferring the blended image to a head sock.

U.S. Pat. No. 5,314,370 issued to Flint on May 24, 1994 shows a doll making process that includes steps of positioning the certain person in front of a video camera, adjusting the position of the person and the camera so that the face fills certain boundaries on a monitor screen, transferring the signal from the video camera to a color transfer printer and printing the resulting image on a wax layer supported on a substrate. The wax layer is pressed and heated against a layer of natural fabric to transfer the wax layer onto the layer of fabric. The fabric layer is secured, image outward, onto the facial area of the doll.

U.S. Pat. No. 5,009,626 issued to Katz on Apr. 23, 1991 shows a three-dimensional lifelike representation of the head portion of a real life subject formed by applying flexible sheet fabric material bearing an imprint of the head portion of a real life subject in the form of a computer-generated printed representation of the head of the subject to a computer-selected substrate structure of configuration and size matched to the printed representation of the head of the subject. The printed representation may take the form of an azimuthal-type group of connected sector photographic projections, a warped photographic image, or a panoramic photographic image of the subjects head portion with the flexible sheet fabric material being of a type capable of conforming to the substrate structure.

U.S. Pat. D462,403 issued to McCraney on Sep. 3, 2002 shows a design for a stress relieving doll in terms of real-life likenesses on a doll head.

Still further, it is known that two-dimensional images can be transformed into three-dimensional representations.

U.S. Pat. No. 7,486,324 issued to Driscoll, Jr. et al. on Feb. 3, 2009 shows a panoramic camera apparatus that instantaneously captures a 360 degree panoramic image. In the camera device, virtually all of the light that converges on a point in space is captured. Specifically, in the camera of the present invention, light striking this point in space is captured if it comes from any direction, 360 degrees around the point and from angles 50 degrees or more above and below the horizon. The panoramic image is recorded as a two dimensional annular image. Specifically, methods and apparatus for digitally performing a geometric transformation of the two dimensional annular image into rectangular projections such that the panoramic image can be displayed using conventional methods such as printed images and televised images.

U.S. Pat. No. 6,916,436 issued to Tarabula on Jul. 12, 2005 shows a method to transform any portion of a two-dimensional visual image into a three-dimensional formed visual image device within the overall two-dimensional visual areas on a single image piece. The resultant image has both two-dimensional and three-dimensional aspects in the same single image piece, or visual device. Furthermore, the present invention provides a method that offers full control of the amount of visual distortion involved in the above processes.

None of the prior art provides an easily customizable life-like head apparatus by a home user for an Internet-based point of sale transaction. It is, therefore, desirable to provide a method of producing an easily customizable life-like head apparatus by a home user for an Internet-based point of sale transaction.

### SUMMARY OF THE INVENTION

It is an object of the present invention to obviate or mitigate at least one disadvantage of previous three-dimensional dolls and the like.

In a first aspect, the present invention provides a method for producing a three dimensional head apparatus, the method including: uploading a digital image including facial features of a real-life subject; selecting a target image area from the digital image; matching peripheral features to the real-life subject; processing the target image area and the peripheral features to produce a three-dimensional representation; generating at least one two-dimensional sheet corresponding to the three-dimensional representation; and forming a tangible embodiment of the three-dimensional representation from the two-dimensional sheet as a head apparatus.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 is an initial screen shot showing the opening step in accordance with the present invention.

FIG. 2 is a subsequent screen shot showing the upload step in accordance with the present invention.

FIG. 3 is a subsequent screen shot showing the skin palette step in accordance with the present invention.

FIG. 4 is a subsequent screen shot showing the hair color and hair style step in accordance with the present invention.

FIG. 5 is a subsequent screen shot showing the final preview step in accordance with the present invention.

### DETAILED DESCRIPTION

Generally, the present invention provides a method for producing a head apparatus. The head apparatus may be in the form of a realistic pillow head or any generally head-shaped formation encased with a flexible material. The pillow head itself is a three-dimensional apparatus providing a realistic representation of a real-life human head. Although the term “pillow head” may be used throughout, it should be understood that the head apparatus may be relatively soft or relatively hard and may be a life-like human head, an exaggerated human head (e.g., a caricature-like humorous depiction), or even a non-human head (e.g., life-like animal or non-real, fantasy character). This three-dimensional representation is derived from a two-dimensional image—e.g., a photo of human subject including a facial image. Although the present invention is discussed in terms of a human subject's facial image, it should be understood that any real-life object embodied in a two-dimensional image may form the basis of the present invention. For example, an animal such as a favorite domestic pet could also be the basis for the pillow head without straying from the intended scope of the present invention.

The method in accordance with the preferred embodiment utilizes the Internet as the mechanism by which a user practices the invention. However, it should be readily apparent that a closed computer network whether in a local area network or a wide area network may also provide a similar mechanism by which the present invention functions. Still further, the present invention will be discussed in terms of a standard desktop computing environment. However, it should be readily apparent that the present invention may be deployed over a computing environment different from such standard desktop including, but not limited to, smartphone device interfaces, portable digital assistant interfaces, a wired or wireless laptop interface, or any similar handheld electronic device interface networked via the Internet or suitable network whether public or private. The method of the present invention is embodied within computer software stored and executed at a computer server (i.e., remote server) located remote from the user.

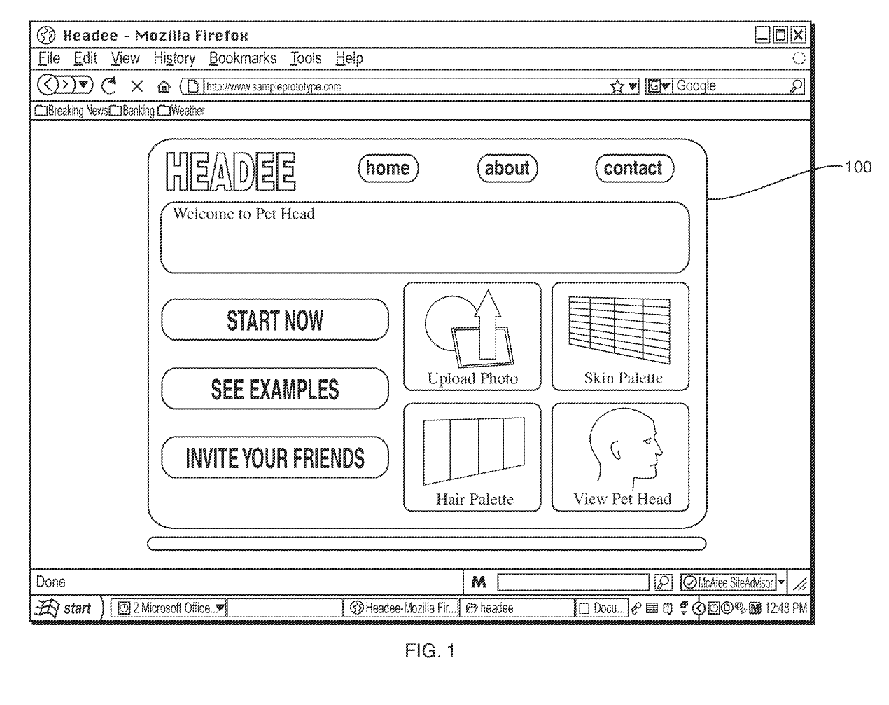

With regard to the figures, a user is presented with an interface as shown in FIG. 1. The interface here is in the form of an opening screen 100 providing overall directions to a user. The opening screen 100 is typical of a computer-based (Internet or intranet) browser whereupon a user may use any combination of keystrokes, mouse movements and clicks, or pointing device actions to interact with menu-driven choices. The opening screen 100 may include standard information regarding contact information, company legal disclaimers, and privacy policies. Moreover, the opening screen 100 along with the subsequent screens described further below may vary in organization and/or layout with more or less information than that shown by way of the figures without straying from the intended scope of the present invention.

In terms of the inventive components, the opening screen 100 includes an overview of the process by which a two-dimensional digital image in the form of a photo is uploaded from the user's computing device (e.g., desktop, laptop, smartphone, . . . etc.) to a remote server. The remote server stores a copy of the two-dimensional digital image for further manipulation by the user in accordance with a further step. It should be understood that the steps of the present invention are delineated in the figures via the user clicking through to the next screen from a preceding step.

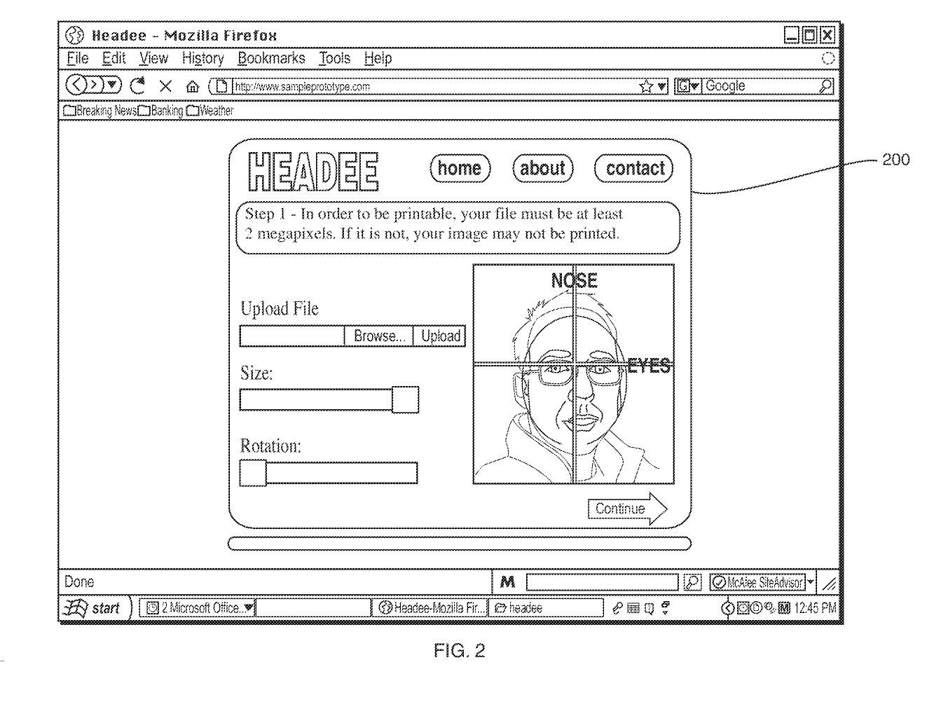

With regard to FIG. 2, an upload screen 200 according to the present invention is shown. Here, a user may browse their local files in a manner known in the computing art and upload a suitable image file. Such image file may be in any suitable file format including, but not limited to, .jpg, .jpeg, .gif, .bmp, or the like without straying from the intended scope of the present invention. Likewise, the image file may preferably be of sufficiently high resolution so as to enable clear reproduction during the inventive method. While it has been shown that an original image file of at least two megapixels is adequate, it may be possible to for a user to upload a low resolution image of less than two megapixels without straying from the intended scope of the present invention. Indeed, whether a low or high resolution is required may be considered a choice made by the user such that a detailed head apparatus may be required or, alternatively, a less detailed head apparatus may be acceptable. While within the upload screen 200, the user may also use an image centering mechanism to adjust for the portion of the image file desired to be used as a “head-shot” of subject. The user may utilize pan, zoom, and/or rotate functions in order to crop, re-orient, and re-size a suitable portion of the original image file.

In FIG. 2, a “sniper's cross-hairs” type of photo preview is shown, though any suitable arrangement may be used to delineate the target area. As shown, the cross-hairs may facilitate proper sizing and alignment of the target area by way of a vertical line provided as a nose alignment target and a horizontal line provided as an eyes alignment target. Using mouse-clicks, keystrokes, sliding touch screen strokes, or the like, a user would “slide” the image around in order to align the eyes and nose of the re-sized target area in order to center the subject's face in the target area image. Once the user is satisfied that the target area image includes the appropriate portion of the subject's head, the user can continue to click through to the next screen. In doing so, the information pertaining to the user's chosen target area image is relayed to the remote server and stored for future digital manipulation in the next step.

It should be understood that the cropped and re-sized target area image from the original image file will include primarily the subject's eyes, nose, mouth, forehead, and possibly some hair that frames the subject's face. However, skin surfaces and hair not shown in the target area image will require digital fabrication. This occurs within the present invention by way of a skin palette screen and a hair palette screen in order to match peripheral features (e.g., hair and skin) to the target area image.

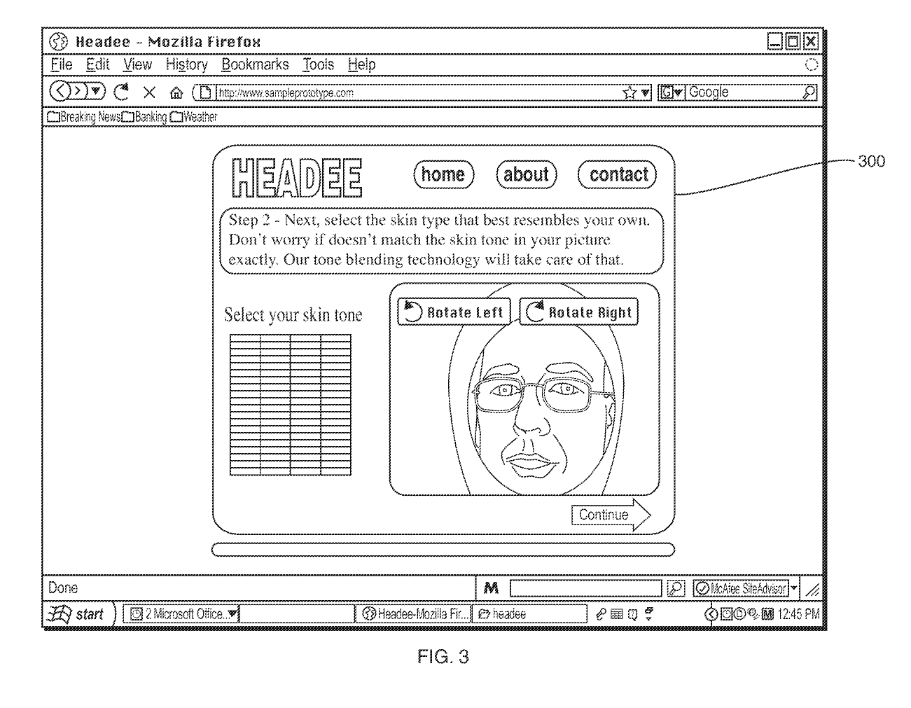

In FIG. 3, the skin palette screen 300 is shown in accordance with the present invention. Here, the user can select a skin tone from a palette of skin tone ranges that most resembles the subject's skin tone as shown in the target area image. Once satisfied, the user again clicks through the next screen. In doing so, the information pertaining to the user's choice of skin tone is relayed to the remote server and stored for future digital manipulation in the next step.

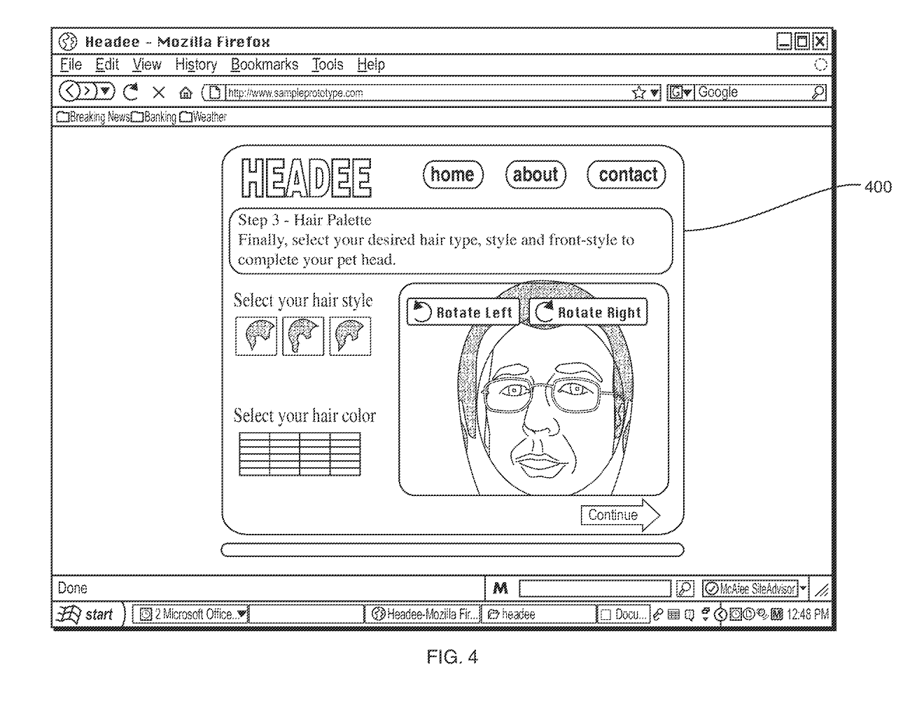

In FIG. 4, the hair palette screen 400 is shown in accordance with the present invention. Here, the user can select from an array of hair styles. Although for purposes of clarity in illustration only three styles are shown, it should be understood that any number of various hairstyles may be provided without straying from the intended scope of the present invention. Indeed, hair style may be accorded its own selection screen as an alternative to the embodiment as shown in FIG. 4 which also includes a hair color selection. Here, the user can select a hair color from a palette of colors that most resembles the subject's hair color. Once satisfied, the user again clicks through the next screen. In doing so, the information pertaining to the user's choice of hair style and color is relayed to the remote server and stored for future digital manipulation in the next step.

It should be understood in regard to FIGS. 3 and 4 that a user may stray from lifelike skin tones and hair styles and colors in order to portray a more artistic, fun, or contrary version of the subject. For example, a balding and pale subject may be altered to include hair and a tan. Likewise, a natural brunette may be altered to become a blonde. Indeed, several variations in the palette choices may be included beyond only skin tone and hair style and color such as, but not limited to, user designated changes to the real-life subject in regard to eye color or digital manipulation of facial features found within the target area image. Such digital manipulation of facial features may include changes to nose shape, eye contours, lip shaping, or any other similar modifications. Such modifications may be for the purposes of idealizing the subject or, contrarily, for the purpose of exaggeration as in a caricature.

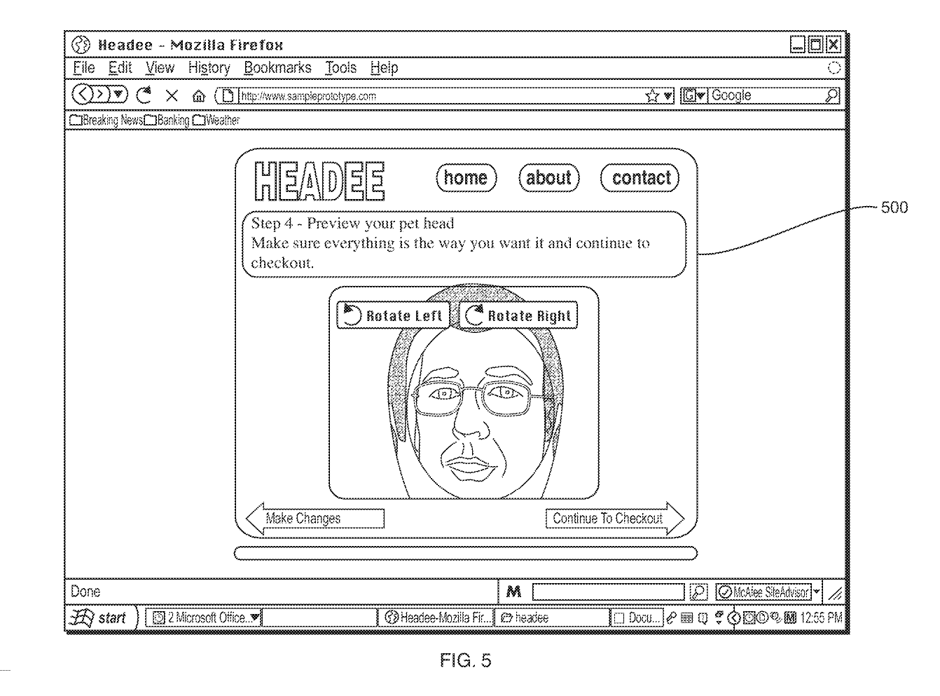

Once a user completes their modifications to the target area image, the user will click through to a viewing screen 500 as shown in FIG. 5. Clicking through to the viewing screen 500 will cause software preferably housed within the remote server to combine the target area image with the user-selected skin tone, hair style, and hair color. By way of digital mapping of the two-dimensional image of the target area image onto a generally humanoid head shape, the remote server processes the additional user-selected skin tone, hair style, and hair color in order to result in a three-dimensional representation. The three-dimensional representation is provided by way of a preview image to the user. The user may rotate the on-screen image horizontally to assess their approval with the three-dimensional representation. Rotation may be provided in a full 360 degree fashion or limited to 180 degrees in either the left or right direction. As well, rotation in any direction (e.g., vertical, horizontal, or there between) may be possible without straying from the intended scope of the present invention. Once the previewed, final head apparatus is approved by the user, the user will “continue to checkout” for an opportunity for an online purchase. This occurs in a manner well known in the electronic commerce field. A user may therefore order and pay for actual fabrication of the three-dimensional representation of the head apparatus.

In terms of fabrication once an order is made and paid for by the user, the remote server will generate production of at least one two-dimensional sheet unique to the user's purchased three-dimensional representation. For purposes of facilitating construction and life-like shaping of the head apparatus formed by the inventive method, it should be understood that more than one two-dimensional sheet may be generated such that multiple images are printed on two or more pieces of fabric and then sewn together. The sheet is produced by known methods of imaging a three-dimensional image onto a two-dimensional sheet as discussed in the background section above. Here, production is rendered upon a pliable fabric suitable for wrapping around soft stuffing in the same manner of fabricating a pillow or a similar object. The resultant tangible item in the instance of the present invention is a soft, pillow-like, three-dimensional physical representation resembling the head of the subject and created by the user. Weighting may be used to simulate the general weight of a human head. In general, the facial features of the three-dimensional physical representation correspond to the target area image of the real-life subject while the hair style and color along with skin tone are user-generated variables.

The end product in accordance with the present invention is therefore a head apparatus that may embody a realistic pillow head product. It should be understood that once an image is processed and customized as outlined above, reproducibility on a mass scale is possible. Indeed, for purposes of mass marketing, the present invention is ideal. Thus a single unique pillow head product may be produced just as easily as many multiple identical pillow head products without straying from the intended scope of the present invention.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for producing a three dimensional head apparatus, said method comprising:
uploading a digital image including facial features of a real-life subject;
selecting a target image area from said digital image;
matching peripheral features to said real-life subject;
processing said target image area and said peripheral features to produce a three-dimensional representation;
generating at least one two-dimensional sheet corresponding to said three-dimensional representation; and
forming a tangible embodiment of said three-dimensional representation from said two-dimensional sheet as a head apparatus.

2. The method as claimed in claim 1, wherein said uploading occurs from local storage immediate to a user of said method to remote storage located at a remote server distant from said user.

3. The method as claimed in claim 2, further including saving said target image area to said remote storage.

4. The method as claimed in claim 2, wherein said selecting is made by said user and includes user-selected adjustments to said digital image in order to form said target image area.

5. The method as claimed in claim 4, wherein said user-selected adjustments include scaling and cropping.

6. The method as claimed in claim 1, wherein said matching includes peripheral features selected from a group consisting of skin tone, hair style, and hair color.

7. The method as claimed in claim 1, wherein said processing of said target image area occurs remote from a user of said method.

8. The method as claimed in claim 1, wherein said forming of said head apparatus occurs remote from a user of said method in response to a real-time purchase and sale of said head apparatus by said user.

9. The method as claimed in claim 2, wherein said local storage consists of a memory forming part of a computing device.

10. The method as claimed in claim 9, wherein said computing device is selected from a group consisting of a desktop computer, a laptop computer, a smartphone, and a personal data assistant.

11. The method as claimed in claim 1, wherein said selecting includes aligning facial features of said real-life subject including nose and eyes with respective cross-hair lines.

12. The method as claimed in claim 1, wherein said selecting includes aligning facial features of said real-life subject including nose and eyes with respective cross-hair lines.

13. The method as claimed in claim 4, wherein said user is provided with a preview capability prior to said forming of said tangible embodiment.

14. The method as claimed in claim 13, wherein said tangible embodiment is formed by more than one of said two-dimensional sheets.

15. The method as claimed in claim 14, wherein said two-dimensional sheets are fabric sewn together to form said head apparatus.
